(19) United States
(12) Patent Application Publication
(10) Pub. No.: US 2004/0114472 A1
(43) Pub. Date: Jun. 17, 2004

(54) POWER CONTROL METHOD OF A PICK-UP HEAD OF AN OPTICAL DISK DRIVE

(76) Inventors: Che-Chieh Wang, Taipei Hsien (TW); Chin-Yin Tsai, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/605,166

(22) Filed: Sep. 12, 2003

(30) Foreign Application Priority Data
Sep. 12, 2002 (TW) 091121068

(51) Int. Cl. G11B 11/00

(52) U.S. Cl. 369/13.26

(57) ABSTRACT

An optical disk drive has a pick-up head for generating a laser beam to record data on an optical disk and for detecting corresponding power of the laser beam, and a power control unit for adjusting power of the laser beam generated by the pick-up head. The power control method includes inputting a plurality of first control signals into the power control unit in order so that the power control unit generates a plurality of first control voltages related to the first control signals for sequentially driving the pick-up head to output a plurality of first test powers, and using the plurality of first test powers and the plurality of first control signals to establish a first mapping function. The optical disk drive uses the first mapping function to get a first predetermined output power and a corresponding first predetermined control signal according to the first mapping function.

### BACKGROUND OF INVENTION

1. Field of the Invention

The present invention relates to a power control method of a pick-up head of an optical disk drive. In particular, the present invention discloses a method of establishing a mapping function related to laser powers of the pick-up head and corresponding control signals for driving the pick-up head, and using the established mapping function to control laser powers of the pick-up head.

2. Description of the Prior Art

For companies or the end users, the management and storage of documents is regarded as an important task. In the past, documents were printed or written on paper. Therefore, when a user deals with a huge amount of documents, it is not convenient for the user to manage those documents because of a great size or a heavy weight. With the development of computer technology, digital data and digital documents are widely stored in a plurality of data storage media. Many kinds of data storage media are developed to help users with those digital data conveniently. An optical disk recorder such as a CD-RW drive takes advantage of recordable compact disks to record data. The compact disk has a low production cost, a small size, and a great storage capacity. Therefore, the user can easily keep data through the compact disk. Generally speaking, the optical disk recorder has to perform an optimum power control (OPC) process to find a most adequate laser power before burning data onto the compact disk. The selected laser power is used to etch the compact disk for forming pits that are used to record binary bits “0”s.

Please refer to FIG. 1, which is a block diagram of a prior art CD-R drive 10. The CD-R drive 10 is used to record data on a CD-R disk. The CD-R drive 10 has a controller 12, a power control unit 14, a pick-up head 16, and a signal converter 18. The controller 12 is used to control operation of the CD-R drive 10. The power control unit 14 is used to adjust laser powers outputted from the pick-up head 16 when the pick-up head 16 records data on the CD-R disk. In addition, the power control unit 14 includes a sample/hold circuit 20, a digital-to-analog converter (DAC) 20, and a driving circuit 24. The sample/hole circuit 20 is used to determine whether a closed loop configuration or an open loop configuration is established between the power control unit 14 and the pick-up head 16. When the sample/hold circuit 20 is enabled, an output port of the sample/hold circuit 20 is capable of holding the signal sampled at an input port of the sample/hold circuit 20. The DAC 22 is used to convert a digital control signal 26 into a corresponding analog control voltage 28. The driving circuit 24 then generates a control voltage 30 according to the control voltage 28 for driving the pick-up head 16 to output a laser beam with a predetermined power. The pick-up head 16, therefore, adjusts the laser power according to the control voltage 30 generated from the power control unit 14. While recording data on the CD-R disk, the pick-up head 16 detects a magnitude of the outputted laser power. With regard to the CD-R drive 10, the pick-up head 10 outputs an incident pulse to etch the CD-R disk, and the incident pulse is reflected from the surface of the CD-R disk to generate a corresponding reflective pulse. A reflected pulse level (B-level defined in a prior art Orange Book) of the reflective pulse stands for deepness of the etched pit. According to the reflected pulse level of the reflective pulse, that is, the actual laser power of the pick-up head 10, the signal converter 18 generates a corresponding feedback signal 32 to the power control unit 14 for further tuning the laser power of the pick-up head 16. If a control signal 26 corresponds to an optimum write power, the closed loop configuration established between the pick-up head 16 and the power control unit 14 will force the laser power of the pick-up head 16 to approach the optimum write power eventually. Writing operation of the CD-R drive 10 is described as follows.

The pick-up head 16 of the CD-R drive 10 is capable of generating laser beams to etch a recording layer on the CD-R disk. The etched area (pit) represents “0”, and the non-etched area (land) represents “1”. Therefore, digital data are recorded on the CD-R disk. However, different CD-R disks have different recording layer characteristics. In other words, different CD-R disks have different power absorption capacities. Therefore, when the same laser power is applied on different CD-R disks, etching deepness of each CD-R disk varies. Based on the above-mentioned reason, each disk manufacturer will record a proposed write power on a lead-in area of the CD-R disk as a reference laser power when manufacturing the CD-R disk. Based on the reference laser power, the CD-R drive 10 then performs the optimum power control to acquire a write power P1 that is suitable for the CD-R disk. After obtaining the write power P1, the CD-R drive 10 begins writing data on the recording layer of the CD-R disk with the help of the write power P1. According to hardware specifications of the pick-up head 16 and the DAC 22, mapping relation between the laser powers outputted from the pick-up head 16 and the control signal 26 driving the pick-up head 16 is determined. For example, when the laser power of the pick-up head 16 equals P1, the required control signal 26 corresponds to a value DAC1 (that is, the control voltage 28 has a corresponding voltage level V1). If the laser power generated from the pick-up head 16 is equal to P2, the signal converter 18 generates a feedback signal 32 corresponding a voltage level V2 according to the laser power P2 detected by the pick-up head 16. When the pick-up head 16 is driven to etch the CD-R disk for recording data, the controller 12 enables the sample/hold circuit 20 to form a closed loop configuration between the pick-up head 16 and the power control unit 14. Because the voltage level V2 is different from the target voltage level V1, the driving circuit 24 adjusts the control voltage 30 according to the voltage levels V1, V2 until the feedback signal 32 and the control voltage 28 have the same voltage level. Then, the laser power P1 of the pick-up head 16 is stabilized to etch the CD-R disk correctly. In other words, each time when the write power of the pick-up head 16 deviates from the target laser power P1, the closed loop configuration established between the pick-up head 16 and the power control unit 14 forces the driving circuit 24 to automatically tuning the erroneous power for recovering the target laser power P1. However, physical characteristics of the pick-up head 16 change after a long period of usage. The mapping relation between the laser power and the corresponding control voltage is not always fixed, so that control voltage used to drive the pick-up head 16 for outputting the target laser power in the beginning does not work over a long period of time. In addition, various circuits disposed in the CD-R drive 10 with decay effects on transmitted signals alter original physical characteristics after a long period of usage. If the CD-R drive 10 uses the control signal DAC_{T1} to drive the pick-up head 16 to output a laser power P_{T1} at time T1, the same control signal DAC_{T1} inputted to the DAC 22 at time T2 will make the laser power outputted from the pick-up head 16 deviate from the previous laser power P1. If the laser power P_{T1} is the optimum write power required by the CD-R drive 10 at time T2, the CD-R drive 10 has to repeatedly perform tuning operations for adjusting the value of the control signal until the outputted laser power becomes P_{T1}. It is well-known that the tuning operations take a long period of time, and the writing efficiency of the CD-R drive 10 is greatly deteriorated. Besides, if the laser power P_{T1} corresponds to high power, the pick-up head 16 might be damaged while performing the repeated tuning operations to detect the outputted high power. Therefore, the life span of the CD-R drive 10 is reduced.

Please refer to FIG. 2, which is a block diagram of a prior art CD-RW drive 40. The CD-RW drive 40 has a controller 42, a power control unit 44, a pick-up head 46, and a signal converter 48. The controller 42 is used to control operation of the CD-RW drive 40. The power control unit 44 is used to adjust laser power outputted from the pick-up head 46 when the pick-up head 46 records data on a CD-RW disk. The power control unit 44 includes a sample/hold circuit 50, a digital-to-analog converter (DAC) 52, a driving circuit 54, and a power amplifier 56. The sample/hold circuit 50 is used to determine whether a closed loop configuration or an open loop configuration is established between the pick-up head 46 and the power control unit 44. The DAC 52 is used to convert a digital control signal 58 into a corresponding analog control voltage 60. The driving circuit 54 generates a control voltage 62 according to the control voltage 60 so as to drive the pick-up head 46 to output laser beams with an erase power. The power amplifier 56 with a gain setting is capable of generating a control voltage 66 according to the control voltage 62. The control voltage 62 and the control voltage 66 are both used to drive the pick-up head 46 to etch the CD-RW disk through a write power. The pick-up head 46, therefore, adjusts its laser power according to the control voltages 62, 66 outputted from the power control unit 44. The writing operation of the CD-RW drive 40 is briefly described as follows.

Please refer to FIG. 3, FIG. 4, and FIG. 5. FIG. 3 is a first equivalent circuit 70 of the CD-RW drive 40 shown in FIG. 2. FIG. 4 is a second equivalent circuit 80 of the CD-RW drive 40 shown in FIG. 2. FIG. 5 is a third equivalent circuit 90 of the CD-RW drive 40 shown in FIG. 2. Because the CD-RW drive 40 is capable of performing writing operations and erasing operations on the same CD-RW disk, the pick-up head 46 of the CD-RW drive 40 requires a write power for generating pits used to represent “0”s, and an erase power for removing pits and forming lands used to represent “1”s. The erase power is capable of clearing data recorded on the CD-RW disk. In other words, the erase power heats the recording layer of the CD-RW disk so that the surface of the whole recording layer is polished without any existing pits. Therefore, recorded data are cleared by the erase power. According to a limitation defined in the Orange Book, the erase power Pe is proportional to the write power Pw according to a predetermined ratio #, that is, Pe=#*Pw. Because the write power Pw is greater than the erase power Pe, the CD-RW drive 40 generally searches for a stable erase power Pe first through the optimum power control. Then, the desired write power Pw is obtained directly by the erase power Pe and the equation (Pe=#*Pw). In other words, if the erase power Pe is successfully set, the required write power Pw is easily obtained without any additional tuning operations. Generally speaking, the write power used by the CD-R drive is equivalent to the erase power used by the CD-RW drive. As mentioned above, the CD-RW drive 40 has to find the suitable erase power Pe first. The first equivalent circuit 70 shown in FIG. 3 is similar to the block diagram of the CD-R drive 10 shown in FIG. 1. The sample/hold circuit is enabled so that the closed loop configuration is established between the pick-up head 46 and the power control unit 44. The output port of the sample/hold circuit 50 holds the signal sampled at the input port of the sample/hold circuit 50. After the pick-up head 46 detects its laser power, the signal converter 48 converts the detected power into a corresponding feedback signal, and transmits the feedback signal to the sample/hold circuit 50. The first equivalent circuit 70, therefore, is mainly used to the erase power, and its operation is identical to that of the CD-R drive 10 for acquiring the write power. The lengthy description is skipped for simplicity. Because the CD-RW drive 40 does not perform the optimum power control upon the write power Pw, the sample/hold circuit 50 is disabled when the CD-RW drive 40 starts etching the CD-RW disk with the write power Pw. Therefore, the open loop configuration is then established between the pick-up head 46 and the power control unit 44. The closed loop configuration and the open loop configuration are different operating conditions for the CD-RW drive 40. Generally speaking, when the pick-up head 46 outputs predetermined laser power, the value required by the control signal 58 to drive the pick-up head 46 to output the predetermined laser power under the open loop configuration is greater than the value under the closed loop configuration. As shown in FIG. 4, because the erase power Pe is obtained in the closed loop configuration, the CD-RW drive 40 under the open loop configuration has to adjust the control signal 58 corresponding to the erase power Pe through the second equivalent circuit 80 until the control voltage 62 can drive the pick-up head 46 to output the erase power Pe. As mentioned above, the erase power Pe is proportional to the write power Pw according to a predetermined ratio #, that is, Pe=#*Pw. The write power Pw then is acquired by the above equation. In the third equivalent circuit 90 shown in FIG. 5, the control voltage 62 willpass to the power amplifier 56 so that the control voltage 62 is amplified according to a gain value for generating the control voltage 66. Owing to the decay effect upon signals, the gain value of the power amplifier 56 set according to the predetermined ratio # is not capable of generating a correct control voltage 66 to force the pick-up head 46 to output the target write power Pw. Therefore, the gain value is adjusted repeatedly, and the pick-up head 46 also continuously detects its output power until the laser power outputted from the pick-up head 46 is equal to the write power Pw. Then, the control voltages 62, 66 simultaneously drive the pick-up head 46 to output the write power Pw for forming pits on the CD-RW disk. However, the write power Pw is high power. If the pick-up head 46 detects the write power Pw, the corresponding reflective pulse will damage the pick-up head 46 so that the pick-up head 46 malfunctions. In addition, physical characteristics of the pick-up head 46 change after a long period of usage. The mapping relation between the laser power and the corresponding control voltage is not always fixed so that control voltage used to drive the pick-up head 46 for outputting the target laser power in the beginning does not work over a long period of time. In addition, various circuits disposed in the CD-RW drive 40 alter original physical characteristics, decay effect upon signals for example, after a long period of usage. Therefore, the CD-RW drive 40 needs a longer period of time to tune the gain value of the power amplifier 56. Because the tuning operations take a long period of time, and the writing efficiency of the CD-RW drive 40 is greatly deteriorated.

### SUMMARY OF INVENTION

It is therefore a primary objective of the claimed invention to provide a power control method of testing the pick-up head under a low power condition and establishing a mapping function for representing actual laser power characteristics of the pick-up head to solve the above-mentioned problem.

Briefly summarized, the preferred embodiment of the claimed invention discloses a power control method for controlling a laser power used by an optical disk drive to record data on an optical disk. The optical disk drive has a pick-up head for generating a laser beam to record data on the optical disk and measuring the laser power corresponding to the laser beam, a converter for converting the laser power measured by the pick-up head into a feedback signal, and a power control unit for adjusting the laser power outputted from the pick-up head. The power control unit includes a digital-to-analog converter (DAC) for converting a first control signal into a first control voltage, and a sample/hold circuit for controlling whether the feedback signal is fed back to the power control unit. The power control method includes sequentially inputting a plurality of first control signals into the DAC so that the DAC sequentially outputs a plurality of first control voltages to the pick-up head for driving the pick-up head to sequentially output a plurality of first test laser powers after enabling the sample/hold circuit, using the pick-up head for measuring the first test laser powers, and using the first control signals and the first test laser powers for establishing a first mapping function. The optical disk drive uses the first mapping function for calculating a first predetermined laser power and a first predetermined control signal, and the first predetermined control is used for driving the pick-up head to output the first predetermined laser power.

It is an advantage of the claimed invention that power tests are performed under a low power condition to figure out mapping functions and to prevent the pick-up head from being damaged. The value of the control signal for driving the pick-up head to output a predetermined power is quickly and easily obtained through the mapping function. The data recording performance of the optical disk drive is greatly improved.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a block diagram of a prior art CD-R drive.

FIG. 2 is a block diagram of a prior art CD-RW drive.

FIG. 3 is a first equivalent circuit of the CD-RW drive shown in FIG. 2.

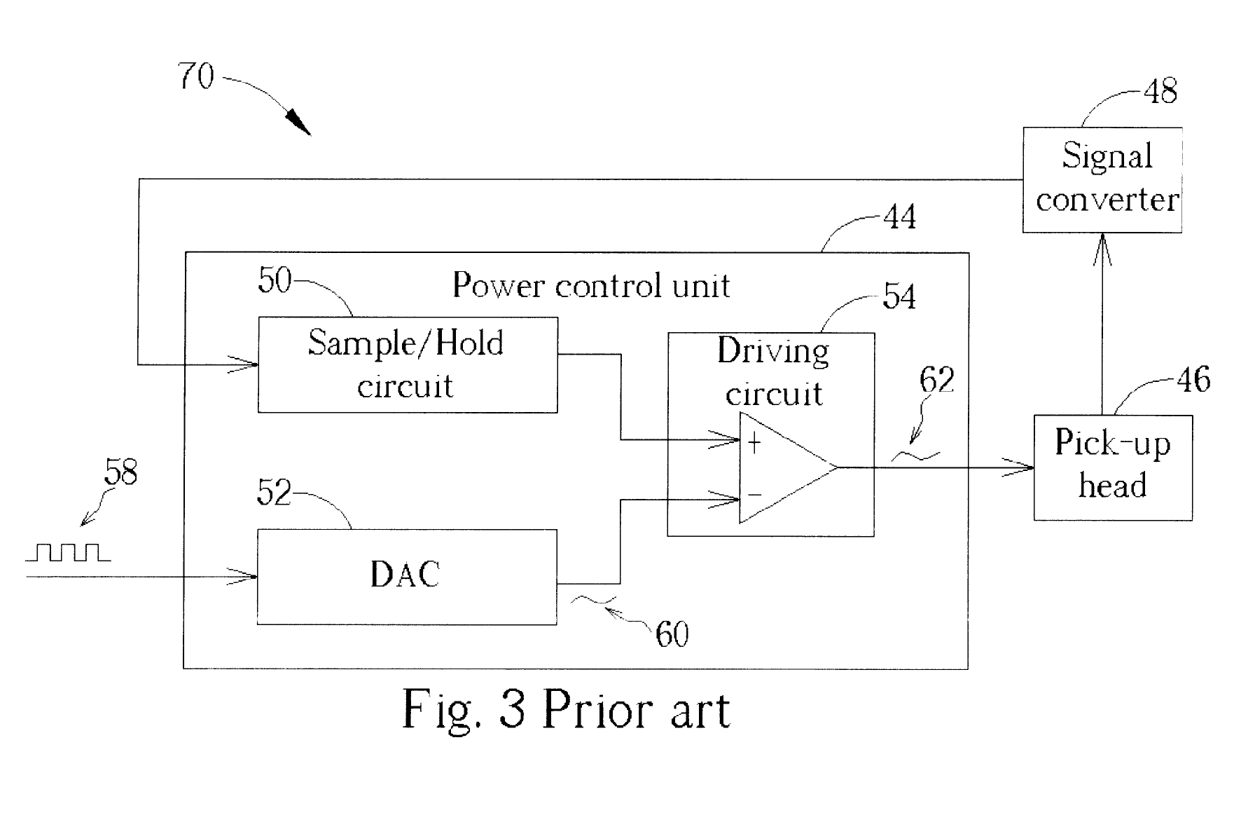

FIG. 4 is a second equivalent circuit of the CD-RW drive shown in FIG. 2.

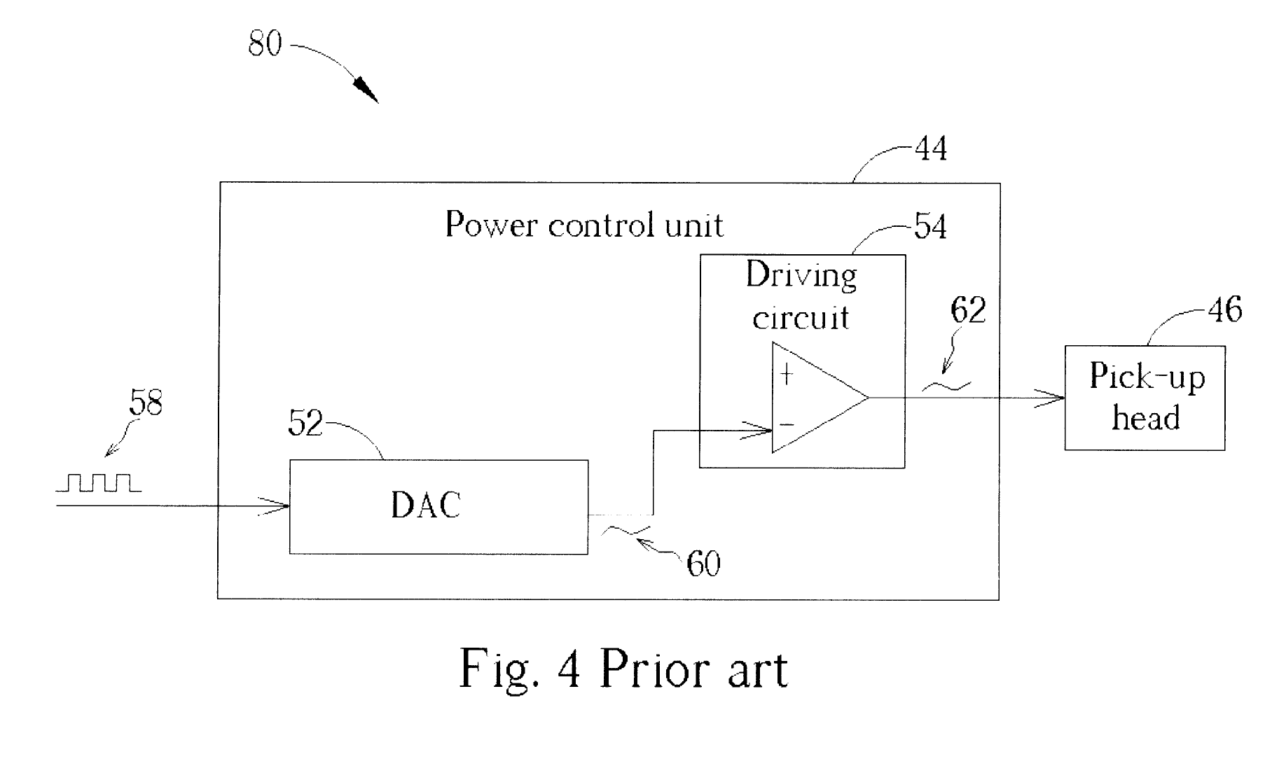

FIG. 5 is a third equivalent circuit of the CD-RW drive shown in FIG. 2.

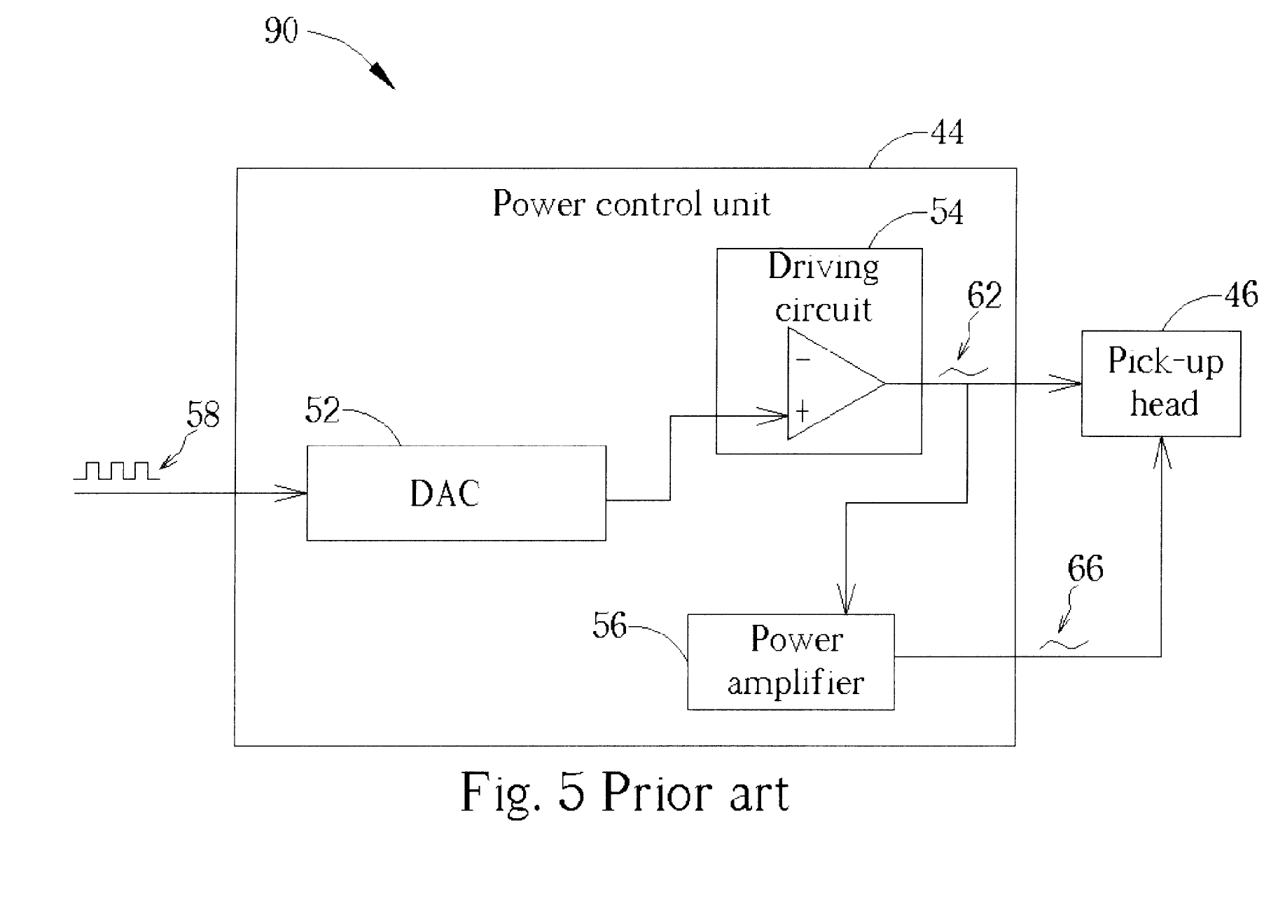

FIG. 6 is a flow chart of a first power control method according to the present invention.

FIG. 7 is a laser power diagram of a pick-up head shown in FIG. 1 according to the first power control method.

FIG. 8 is a flow chart of a second power control method.

FIG. 9 is a laser power diagram of a pick-up head shown in FIG. 2 according to the second power control method.

FIG. 10 is a gain value diagram of a power amplifier shown in FIG. 2 according to the second power control method.

### DETAILED DESCRIPTION

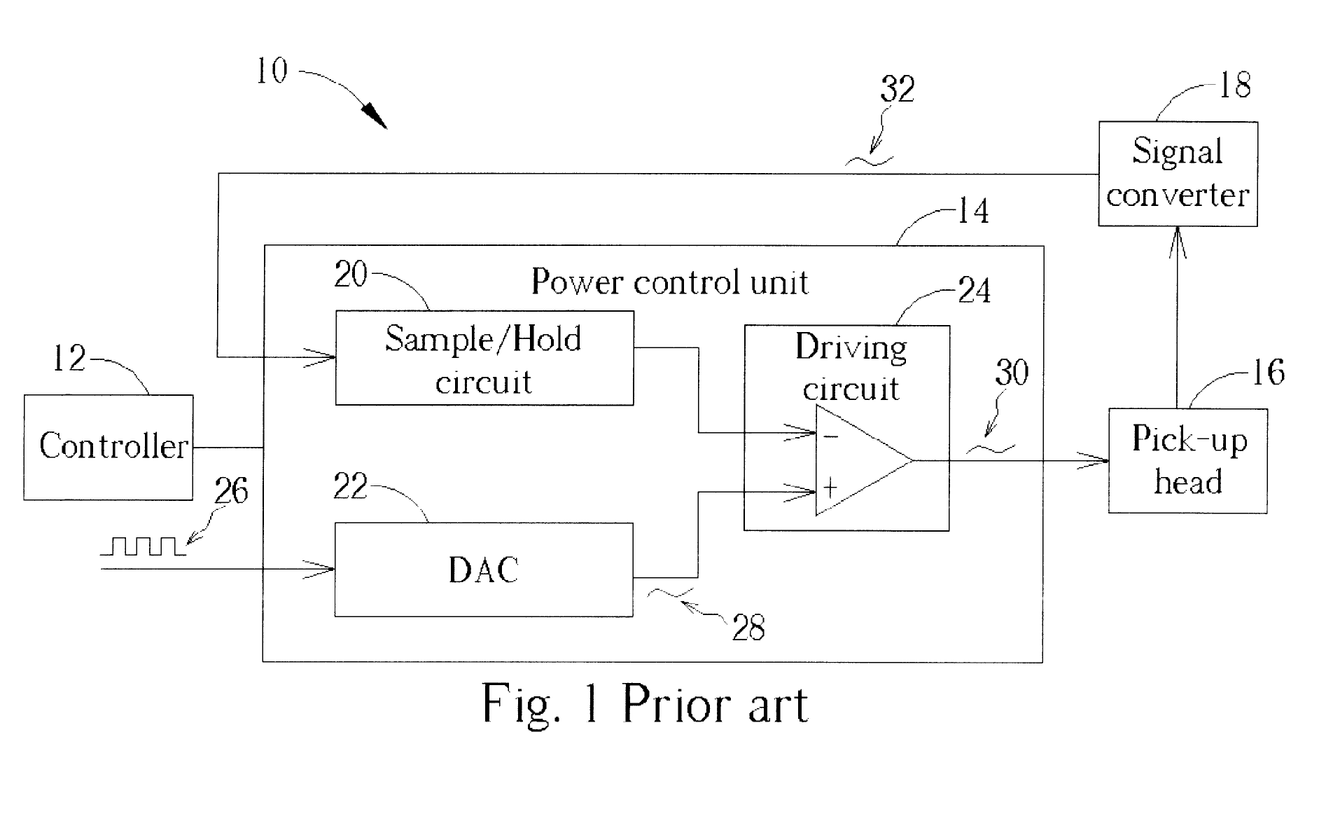

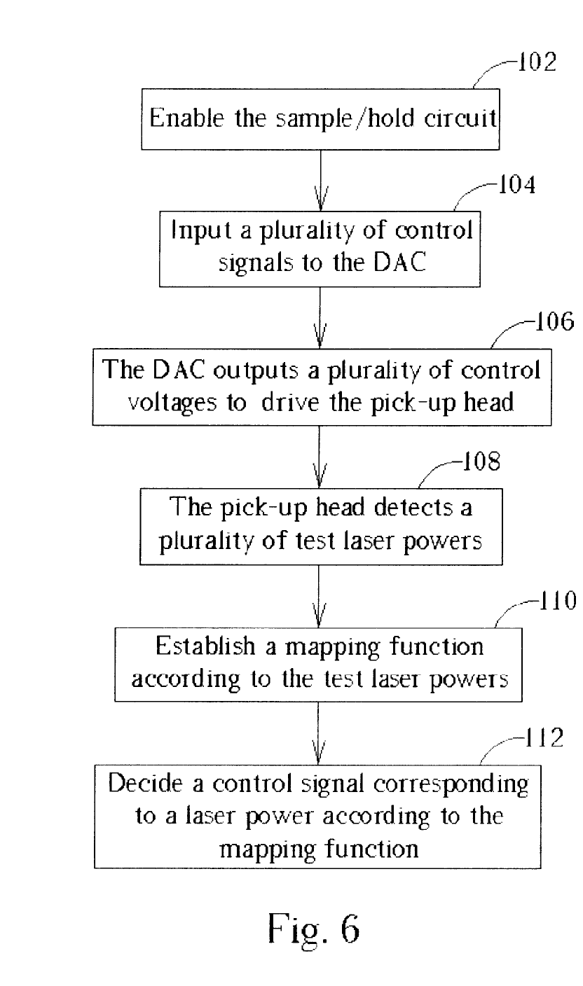

Please refer to FIG. 6 in conjunction with FIG. 1. FIG. 6 is a flow chart of a first power control method according to the present invention. The first power control method includes following steps.

Step 102: Enable the sample/hold circuit 20;

Step 104: Input a plurality of control signals 26 to the DAC 22;

Step 106: The DAC 22 sequentially converts the control signals 26 into corresponding control voltages 28 for sequentially driving the pick-up head 16;

Step 108: The pick-up head 16 sequentially detects a plurality of test laser powers;

Step 110: Establish a mapping function according to the test laser powers; and

Step 112: Decide a control signal corresponding to a laser power according to the mapping function.

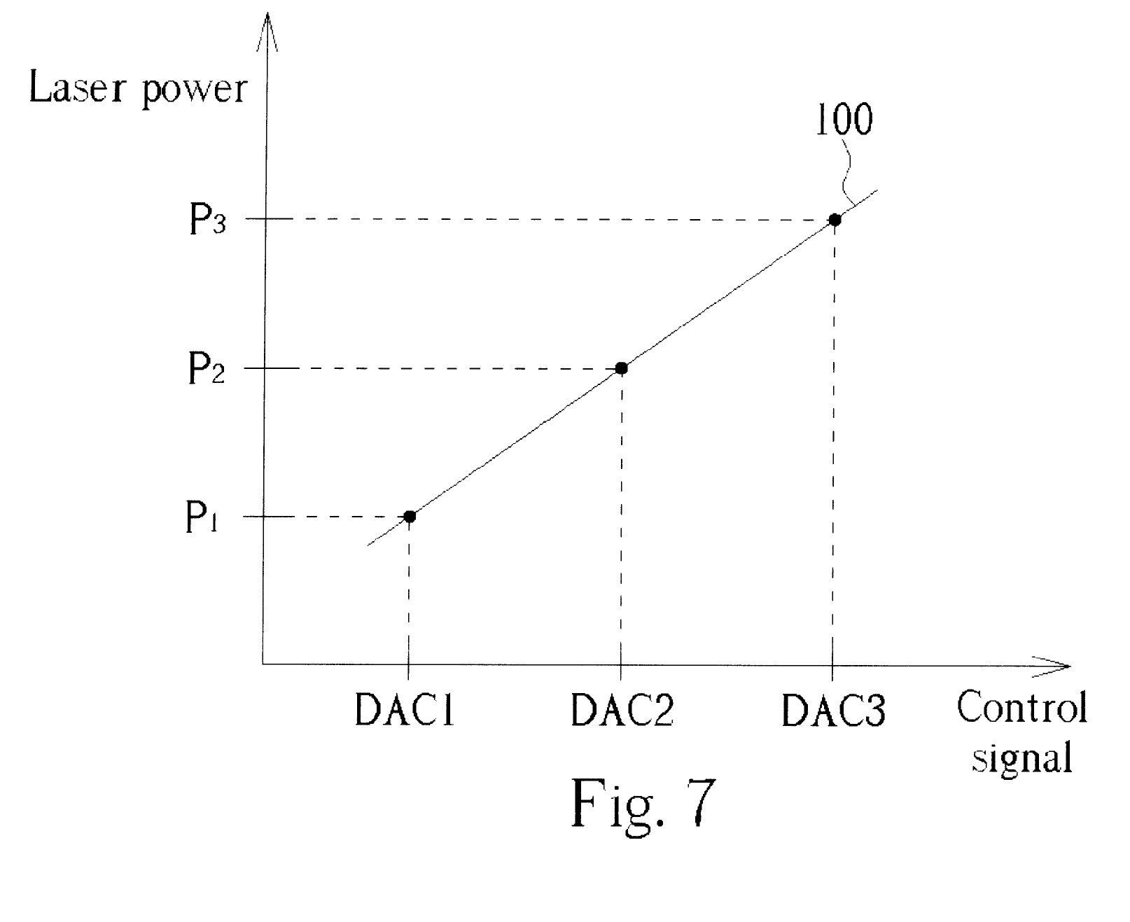

Operation of the power control method according to the present invention is described as follows. With regard to the CD-R drive 10 shown in FIG. 1, the sample/hold circuit 20 is first enabled to establish a closed loop configuration between the pick-up head 16 and the power control unit 14 (step 102). The output port of the sample/hold circuit 20 holds the signal sampled at the input port of the sample/hold circuit 20. Then, a plurality of control signals 26 corresponding to different values are sequentially inputted to the DAC 22 (step 104). The DAC 22, therefore, sequentially converts the received control signals 26 into corresponding control voltages 28, and the control voltages 28 are transmitted to the driving circuit 24. The driving circuit 24 sequentially generates control voltages 30 according to the received control voltages 28 for driving the pick-up head 16 (step 106). Each control signal 26 drives the pick-up head 16 to generate laser beams with a corresponding laser power for etch the CD-R disk. At the same time, the pick-up head 16 detects magnitude of the laser power. In addition, the closed loop configuration makes the pick-up head 16 output stable laser power corresponding to the control signal 26 (step 108). The pick-up head 16 sequentially detects a laser power corresponding to each of the control signals 26. The detected laser power is the actual power outputted from the pick-up head 16. Aging of the pick-up head 16 and influences of the circuits disposed in the CD-R drive 10 make the actual laser power driven by the control signal 26 deviate from an ideal laser power, but the preferred embodiment generates a mapping function according to the control signals 26 and corresponding actual laser powers without considering the ideal laser powers. That is, the established mapping function is capable of representing a function relation between the control signal 26 and the actual laser power of the pick-up head 16 when the CD-R drive operates. The actual behavior of the CD-R drive is obtained. Generally speaking, a prior art polynomial curve fitting method can be used to generate the mapping function (step 110). After the mapping function is obtained, the CD-R drive 10 is capable of easily determining value of the control signal 26 corresponding to a desired write power, and drives the pick-up head 16 to record data on the CD-R disk according to the calculated control signal 26. Please refer to FIG. 7, which is a laser power diagram of the pick-up head 16 shown in FIG. 1 according to the first power control method. The horizontal axis represents values of the control 26, and the vertical axis represents laser powers of the pick-up head 16. When the value of control signal 26 equals DAC1, the actual laser power of the pick-up head equals P1. When the value of control signal 26 equals DAC2, the actual laser power of the pick-up head equals P2. The preferred embodiment, therefore, is capable of quickly figuring out the mapping function 100 through the values DAC1, DAC2 of the control signal 26 and the corresponding laser powers P1, P2. Please note that the preferred embodiment only uses two test results to quickly obtain the mapping function 100 by a straight-line relation. However, if more tests are performed, the prior art polynomial curve fitting can be used to calculate the mapping function 100. Therefore, when the CD-R drive 10 needs the laser power P3 to record data on the CD-R disk. With the help of the mapping function 100, the required value DAC3 of the control signal 26 is quickly got. In the preferred embodiment, the laser powers P1, P2 are both low powers, and the pick-up head 16 is not damaged during the testing process. In addition, when the mapping function 100 is established under a low power condition, the mapping function 100 then can be used to get value of control signal 26 under a high power condition. Therefore, when the CD-R drives 10 requires a high power (P3 for example) to record data, the corresponding control signal 26 having a value DAC3 is directly obtained through the mapping function 100 for driving the pick-up head 16. In other words, the preferred embodiment simplifies prior art tuning operations and related operation time. The writing efficiency is greatly improved, and the damage to the pick-up head 16 is prevented because the pick-up head 16 is not driven under a high laser power condition.

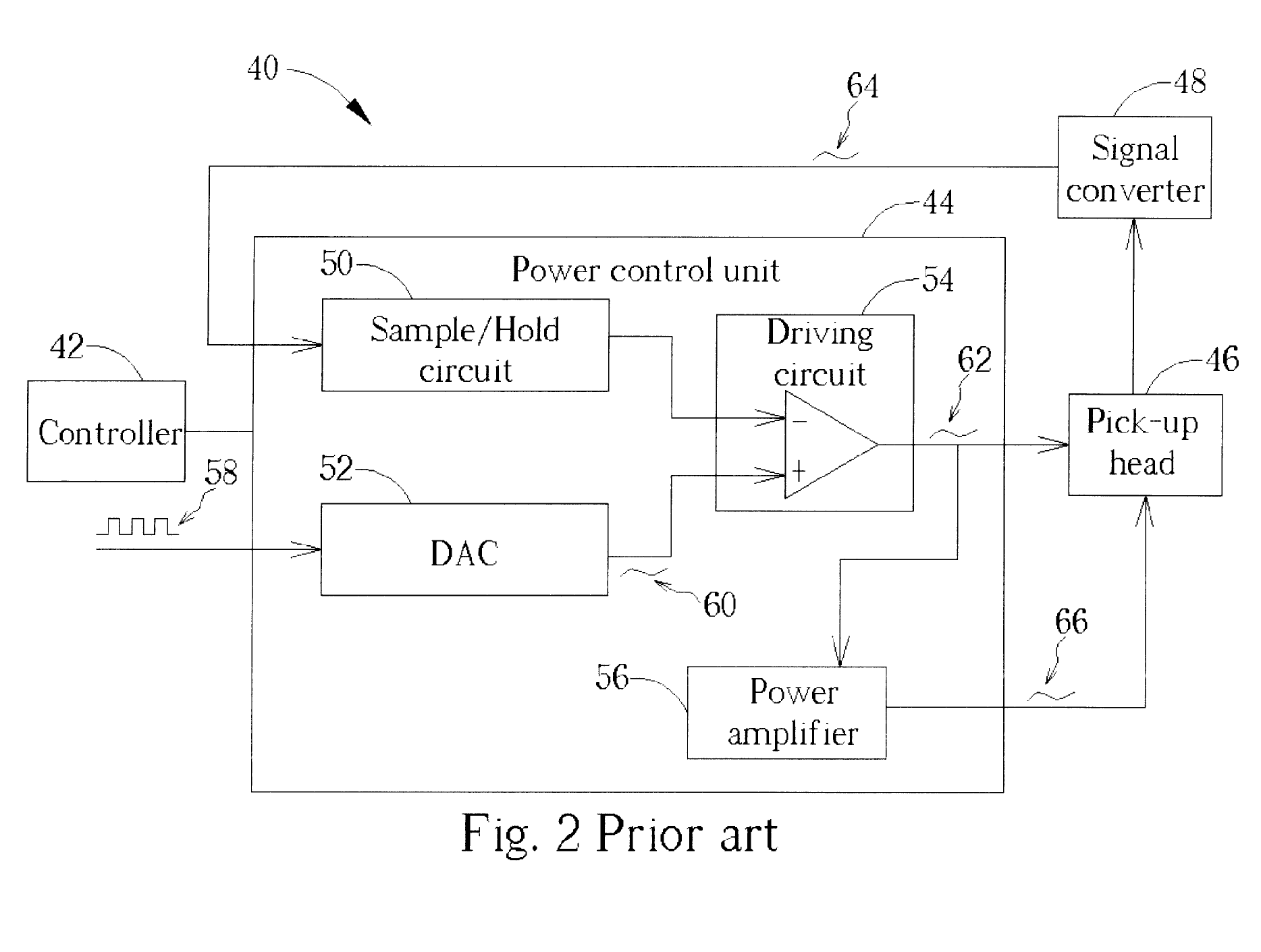

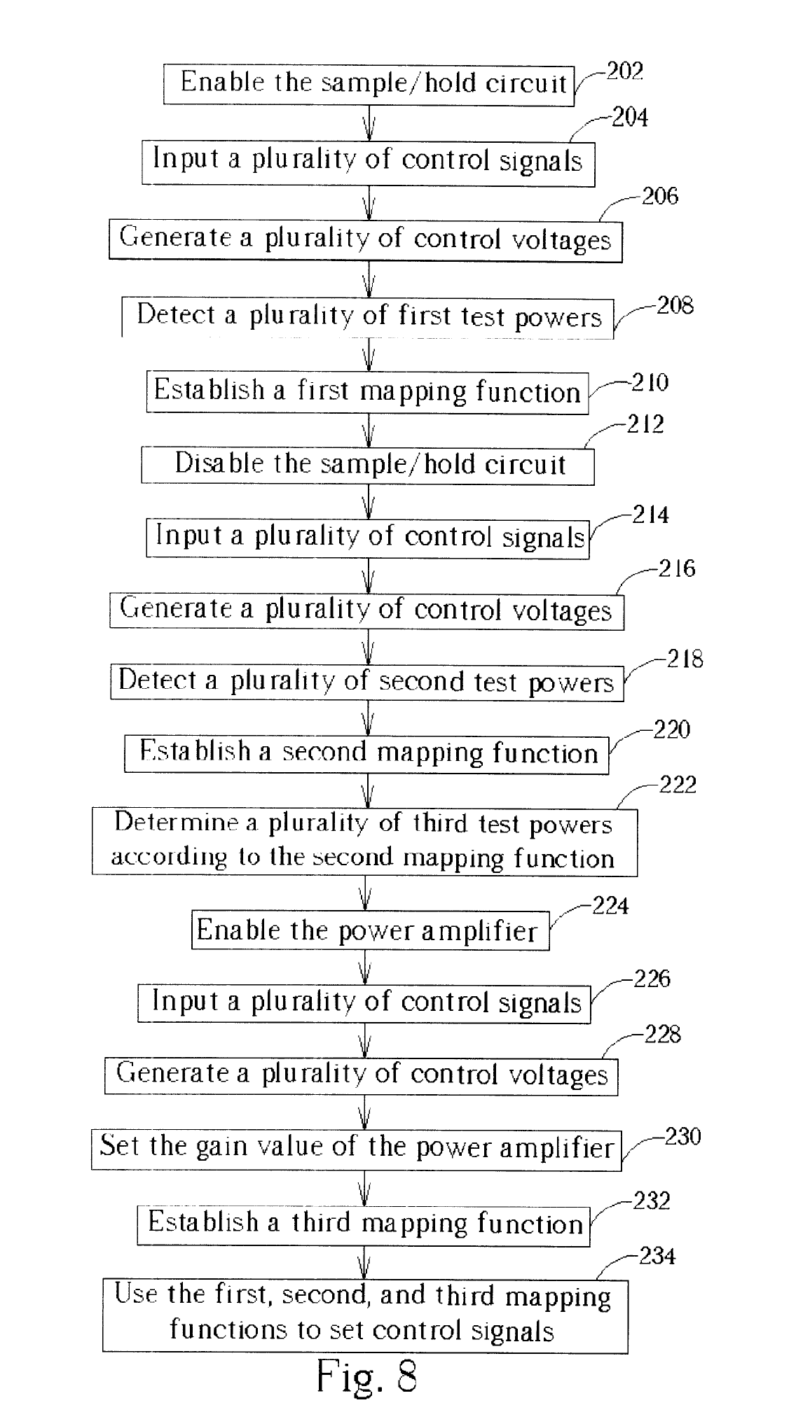

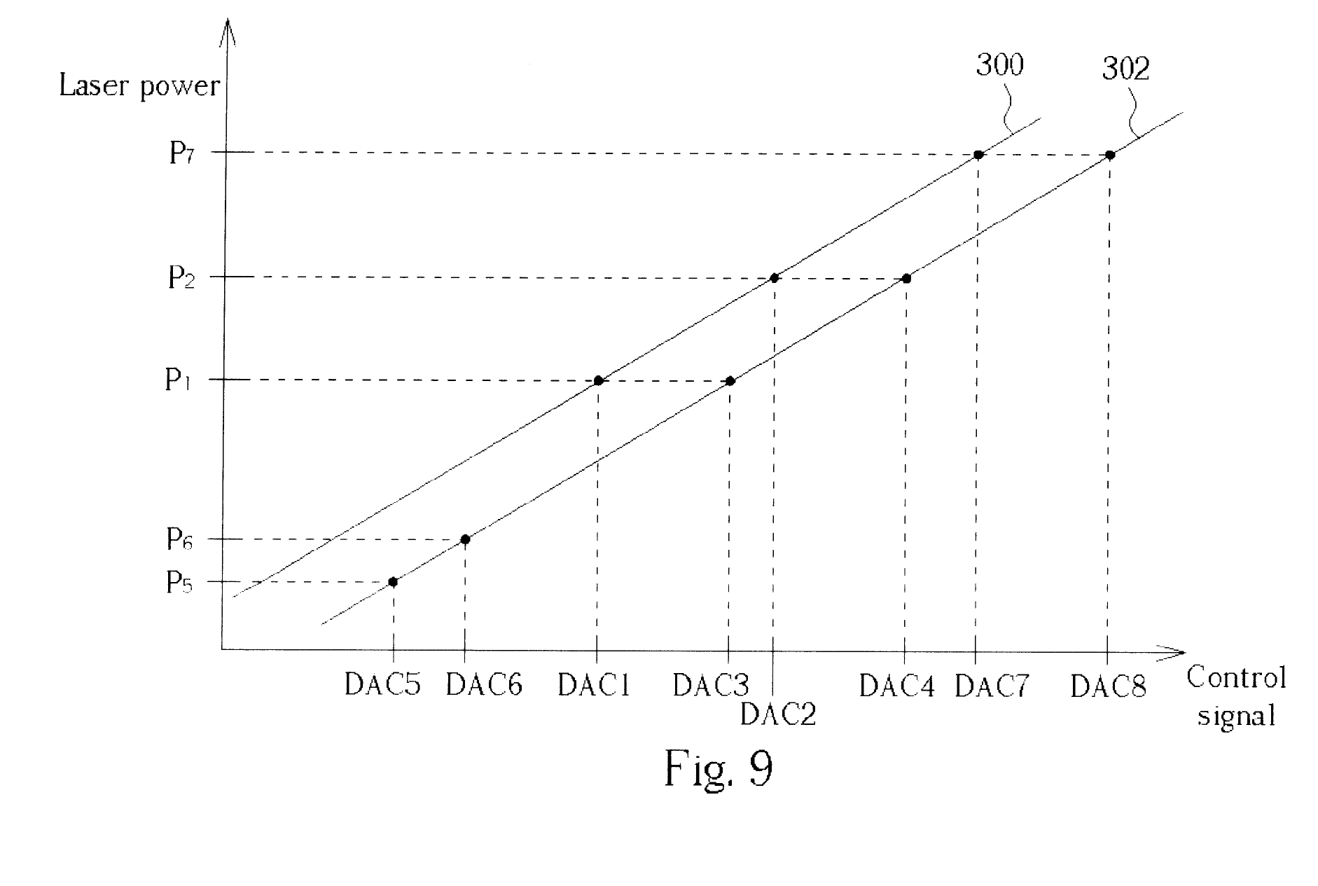

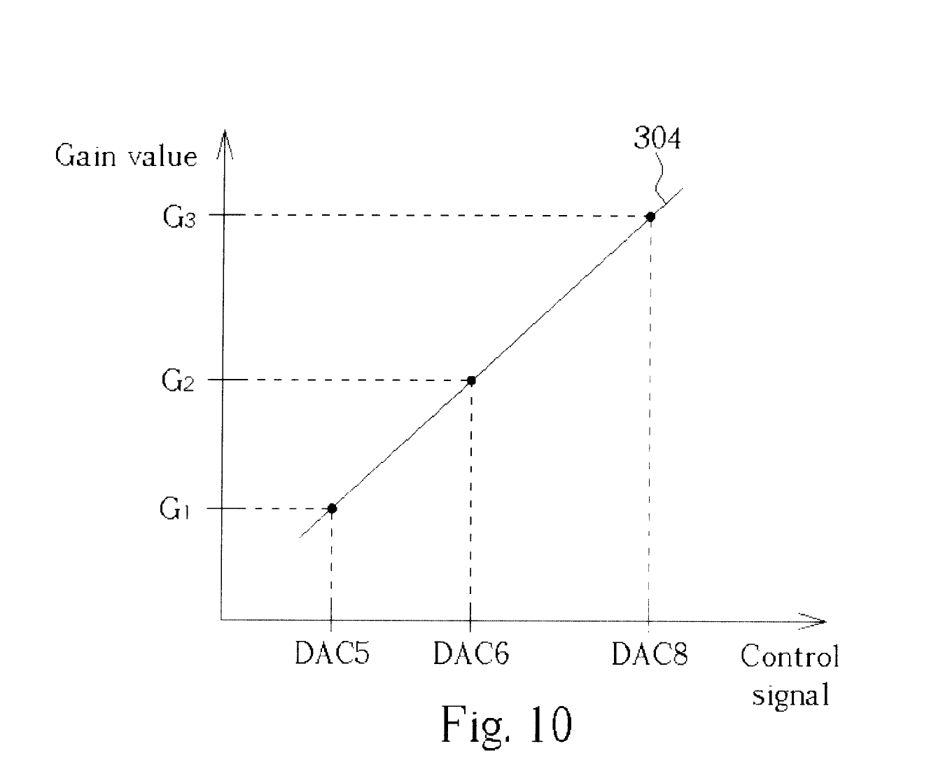

Please refer to FIG. 2, FIG. 8, FIG. 9, and FIG. 10. FIG. 8 is a flow chart of a second power control method. FIG. 9 is a laser power diagram of the pick-up head 46 shown in FIG. 2 according to the second power control method. FIG. 10 is a gain value diagram of the power amplifier 56 shown in FIG. 2 according to the second power control method. With regard to FIG. 9, the horizontal axis stands for values of the control signal 58, and the vertical axis stands for laser power of the pick-up head 46. With regard to FIG. 10, the horizontal axis stands for values of the control signal 58, and the vertical axis stands for gain values of the power amplifier 58. The second power control method of the present invention includes the following steps.

Step 202: Enable the sample/hold circuit 50;

Step 204: Input a plurality of control signals 58 to the DAC 52;

Step 206: The DAC 52 sequentially converts the received control signals 58 into corresponding control voltages 60 for sequentially driving the pick-up head 46;

Step 208: The pick-up head 46 sequentially detects a plurality of first test powers;

Step 210: Establish a first mapping function according to the first test powers;

Step 212: Disable the sample/hold circuit 50;

Step 214: Input a plurality of control signals 58 to the DAC 52;

Step 216: The DAC 52 sequentially converts the received control signals 58 into corresponding control voltages 60 for sequentially driving the pick-up head 46;

Step 218: The pick-up head 46 sequentially detects a plurality of second test powers;

Step 220: Establish a second mapping function according to the second test powers;

Step 222: Determine third test powers corresponding to a plurality of control signals 58 with the help of the second mapping function;

Step 224: Enable the power amplifier 56;

Step 226: Input the control signals 58 to the DAC 52;

Step 228: The DAC 52 sequentially converts the received control signals 52 into a plurality of control voltages 60 for driving the pick-up head 46;

Step 230: Sequentially adjust the gain values of the power amplifier 56 to make each laser power of the pick-up head 46 equal each third test power, which corresponds to each of the inputted control signals 58, multiplied by a predetermined coefficient;

Step 232: Establish a third mapping function according to the control signals 58 and corresponding gain values of the power amplifier 56;

Step 234: Set the value of the control signal 58 used to drive the pick-up head 46 through the first, second, and third mapping functions.

The second power control method according to the present invention is described as follows. The above-mentioned procedure for calculating a mapping function related to write powers of the CD-R drive can be also applied to the CD-RW drive 40. It is well-known that the write power of the CD-R drive 10 corresponds to the erase power of the CD-RW drive 40. The CD-R drive 10 utilizes a closed loop configuration to steadily output the write power. The CD-RW drive 40, similarly, adopts a closed loop configuration to steadily output the erase power for forming land. But, the CD-RW drive 40 utilizes an open loop configuration to drive the pick-up head 46 to output a write power. Therefore, the CD-RW drive 40 has to use the closed loop configuration to acquire an adequate erase power of the CD-RW disk in the beginning. Then, the CD-RW drive 40 uses the open loop configuration to decide a control signal corresponding to a write power based on the erase power, and tunes a gain value of the power amplifier 56 to generate the required write power used to etch the CD-RW disk for recording “0”s. However, if the CD-RW drive 40 wants to record “1”s, the erase power is then used to polish the CD-RW disk for recording “1”s. In addition, the closed loop configuration is switched on to stabilize the outputted erase power. In other words, the pick-up head 46 will detect its laser power while polishing the CD-RW disk by the outputted laser power. If the laser power deviates from the desired erase power, the closed loop configuration is automatically actuated to adjust the laser power of the pick-up head 46 until the laser power is equal to the erase power. The CD-RW drive 40 is similar to the CD-R driver 10 so that the sample/hold circuit 50 is first disabled to figure out the mapping function related to the erase power and the control signal 58. The detailed operation is described as follows.

First of all, the CD-RW drive 40 enables the sample/hold circuit 50 so that a closed loop configuration is established between the pick-up head 46 and the power control unit 44 (step 202). A plurality of control signals 58 with different values are sequentially inputted to the DAC 52 (step 204). The DAC 52, therefore, sequentially receives the control signals 58, and sequentially outputs a plurality of corresponding control voltages 60 to the driving circuit 54. The driving circuit 54 then outputs control voltages 60 with different voltage levels according to the received control voltages 60 for sequentially driving the pick-up head 46 (step 206). Each control signal 58 drives the pick-up head 46 to output laser beams with a predetermined power for etching the CD-RW disk. At the same time, the pick-up head 46 detects the predetermined power outputted from the pick-up head 46 itself, and the closed loop configuration automatically operates to force the pick-up head 46 to generate a stable laser power (step 208). Because the pick-up head 46 detects an outputted laser power, which is an actual power of the pick-up head 46 corresponding to each inputted control signal 58, the aging of the pick-up head 46 and the decay effect caused by the circuits disposed in the CD-RW drive 40 are considered. In other words, the output powers of the pick-up head and the corresponding control signals 58 are utilized to establish a first mapping function 300 that represents a relation between the control signal 58 and the output power of the pick-up head 46. The first mapping function 300 reveals actual operation behavior of the CD-RW drive 40. As shown in FIG. 9, when the value of the control signal 58 corresponds to DAC1, the laser power of the pick-up head 46 equal P1, and when the value of the control signal 58 corresponds to DAC2, the laser power of the pick-up head 46 equal P2. The preferred embodiment, therefore, is capable of obtaining the first mapping function 300 quickly by a straight-line relation. With a plurality of test operations, the first mapping function 300, similarly, can be figured out by the prior art polynomial curve fitting.

After acquiring the first mapping function 300, the CD-RW drive 40 then disables the sample/hold circuit 50 for establishing an open loop configuration between the pick-up head 46 and the power control unit 44 (step 212). A plurality of control signals with different values are sequentially inputted to the DAC 52 (step 214). The DAC 52, therefore, sequentially receives the inputted control signals 58, and outputs a plurality of corresponding control voltages 60 to the driving circuit 54 at the same time. The driving circuit 54 then generates control voltages 62 according to the inputted control voltages 60 for driving the pick-up head 46 (step 216). Each control signal 58 drives the pick-up head 46 to output laser beams with a predetermined power for etching the CD-RW disk. At the same time, the pick-up head 46 detects magnitude of the predetermined power (step 218). Because the pick-up head 46 detects an outputted laser power, which is an actual power of the pick-up head 46, corresponding to each inputted control signal 58, the aging of the pick-up head 46 and the decay effect caused by the circuits disposed in the CD-RW drive are considered. In other words, the output powers of the pick-up head and the corresponding control signals 58 are utilized to establish a second mapping function 302 that represents a relation between the control signal 58 and the output power (erase power) of the pick-up head 46 (step 220). The second mapping function 302 reveals actual behavior of the CD-RW drive 40 under the open loop configuration. As shown in FIG. 9, when the value of the control signal 58 corresponds to DAC3, the laser power of the pick-up head 46 equal P1, and when the value of the control signal 58 corresponds to DAC4, the laser power of the pick-up head 46 equal P2. The preferred embodiment, therefore, is capable of obtaining the second mapping function 300 quickly by a straight-line relation. With a plurality of test operations, the second mapping function 302, similarly, can be figured out by the prior art polynomial curve fitting. Concerning the same laser power P1 of the pick-up head 46, the CD-RW drive 40 with the open loop configuration requires a greater value of the control signal 58 (DAC3>DAC1).

As mentioned above, the erase power Pe is proportional to the write power Pw according to a predetermined ration # (Pe=#*Pw). The erase power Pe and the write power Pw are respectively used to record “l”s (lands) and “0”s (pits). It is well-known that the write power Pw can be acquired with the help of the erase power Pe. The operation is described as follows. Referring to the second mapping function 302, the control signals having values DAC5, DAC6 correspond to laser powers P5, P6 (erase powers). It is obvious that the corresponding ideal write powers are P5/# and P6/# respectively (step 222). Then, the power amplifier 56 is actuated (step 224). The control signals having values DAC5, DAC6 are inputted to the DAC 52 (step 226). Therefore, the control signal having the value DAC5 makes the driving circuit 54 output the control voltage 62, and the control voltage 62 then introduces the control voltage 66 through the power amplifier 56. Similarly, the control signal having the value DAC6 makes the driving circuit 54 output the control voltage 62, and the control voltage 62 then introduces the control voltage 66 through the power amplifier 56 (step 228). For the control signal having a value DAC5, the control voltage 62 is capable of driving the pick-up head 46 to generate laser power P5. The added control voltage 66, however, will make the pick-up head 46 generate laser power P5/#. In other words, the ideal gain value of the power amplifier 56 is (1−#)/#. Because the decay effect caused by the circuits disposed in the CD-RW drive 40 deviates a required gain value from the ideal gain value (1−#)/#, the gain value of the power amplifier 56 has to be adjusted until the laser power of the pick-up head 46 is equal to P5/#. For example, the gain value of the power amplifier 56 is tuned to be G1. For the control signal having a value DAC6, the gain value of the power amplifier 56, similarly, has to be adjusted until the laser power of the pick-up head 46 is equal to P6/#. For example, the gain value of the power amplifier 56 is tuned to be G2 (step 230). A third mapping function 304 is established according to the control signals having values DAC5, DAC6, and the corresponding gain values G1, G2. The third mapping function 304 represents a relation between the control signal 58 and the gain value required by the power amplifier 56. With a plurality of test operations, the third mapping function 304, similarly, can be figured out by the prior art polynomial curve fitting.

It is noteworthy that the pick-up head 46 in the preferred embodiment has to detect its write power during the process of establishing the third mapping function 304. Because the write power is greater than the erase power, the preferred embodiment utilizes control signals corresponding to small value DAC5, DAC6 to protect the pick-up head 46 from being damaged. That is, the preferred embodiment adopts small laser powers P5/#, P6/# to get the required gain values G1, G2. Therefore, the third mapping function 304 is calculated under a low power condition, and is used to get the parameters such as the gain value of the power amplifier 56 for the high power condition. For instance, when the CD-RW drives 40 needs an erase power equaling P7, the value of the control signal 58 for recording “1”s (lands) is DAC7 according to the first mapping function 300. Similarly, when the CD-RW drive 40 wants to record “0”s (pits), the required value of the control signal 58 is equal to DAC8 according to the second mapping function 302, and the required gain value of the power amplifier 56 for obtaining the desired write power P7/# is equal to G3. In addition, the preferred embodiment utilizes a power calibration area (PCA) on the CD-RW disk for performing above-mentioned laser power tests to obtain the mapping functions.

In contrast to the prior art, the claimed power control method establishes mapping functions related to the outputted laser powers and the corresponding control signals. The mapping function stands for actual behavior of the pick-up head. Influence such as aging of the pick-up head or decay on the transmitting signals for the outputted laser powers is considered and represented by the mapping functions through the actual laser power measurement. Therefore, an actual value of the control signal for driving the pick-up head to output a predetermined power is quickly figured out through the corresponding mapping function. In addition, the claimed power control method performs power tests under a lower power condition. When the wanted mapping function is acquired, various parameters related to the high power condition are directly derived from the acquired mapping function. The claimed power control method, therefore, prevents the pick-up head from being damaged owing to power tests under a high power condition. In other words, the life span of the CD-R drive or the CD-RW drive is increased.

Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A power control method for controlling a laser power used by an optical disk drive to record data on an optical disk, the power control method comprising:
driving a pick-up head of the optical disk drive to sequentially output a plurality of first test laser powers according to a plurality of first control signals; and
establishing a first mapping function according to the first control signals and the first test laser powers;
wherein a first predetermined laser power and a first predetermined control signal is obtained by using the first mapping function, and the first predetermined control signal is used for driving the pick-up head to output the first predetermined laser power.

2. The power control method of claim 1 wherein a closed loop configuration is established when the pick-up head is driven to output the first test laser powers.

3. The power control method of claim 1 wherein the first predetermined laser power is substantially a write power used by a CD-R drive for etching a recording layer of an optical disk.

4. The power control method of claim 1 wherein the first predetermined laser power is substantially an erase power used by a CD-RW drive for erasing data recorded on a recording layer of an optical disk.

5. The power control method of claim 1 further comprising:
driving the pick-up head to output a plurality of second test laser powers according to a plurality of second control signals;
measuring the second test laser powers; and
establishing a second mapping function by using the second control signals and the second test laser powers.

6. The power control method of claim 5 wherein an open loop configuration is established when the pick-up head outputs the second test laser powers according to said second control signals.

7. The power control method of claim 1 further comprising a step of adjusting an amplifying gain adaptive to a current status of the pick-up head according to the first test powers.

8. The power control method of claim 7 further comprising:
using the second mapping function for determining a plurality of third control signals and a plurality of third test laser powers corresponding to the third control signals;
adjusting the amplifying gain to output a plurality of fourth control signals;
using the third and fourth control signals for driving the pick-up head to output a plurality of fourth test laser powers; and
using the third control signals and corresponding amplifying gains for establishing a third mapping function;
wherein each of the fourth test laser powers is proportional to a corresponding third test laser power according to a predetermined ratio.

9. The power control method of claim 8 wherein the third test laser powers substantially indicates erase powers of a CD-RW drive, corresponding to the third control signals, and the fourth test laser powers substantially indicates write powers of the CD-RW drive corresponding to the third control signals.

10. The power control method of claim 8 wherein an open loop configuration is established when adjusting the amplifying gain.

11. A power control method for controlling a laser power used by an optical disk drive to record data on an optical disk, the power control method comprising:
deriving and measuring a plurality of first test laser powers;
establishing a first mapping function according to first control signals and the first test laser powers;
determining a plurality of third control signals and a plurality of corresponding third test laser powers according to the first mapping function;
adjusting an amplifying gain adaptive to a current status of the pick-up head to so as output a plurality of fourth control voltages;
using the third control voltages and the fourth control voltages for driving the pick-up head to output a plurality of fourth test laser powers; and
using the third control signals and the corresponding amplifying gains to establish a second mapping function;
wherein each of the fourth test laser powers is proportional to a corresponding third test laser power according to a predetermined ratio.

12. The power control method of claim 11 wherein the third test laser powers substantially indicates erase powers of a CD-RW drive corresponding to the third control signals, and the fourth test laser powers substantially indicates write powers of the CD-RW drive corresponding to the third control signals.

13. The power control method of claim 11 further comprising:
deriving a plurality of fifth control voltages to drive the pick-up head to output a plurality of fifth test laser powers;
using the pick-up head for measuring the fifth test laser powers; and
using the fifth control signals and the fifth test laser powers for establishing a fifth mapping function;
wherein the optical disk drive uses the fifth mapping function for calculating a first predetermined laser power and a first predetermined control signal, and the first predetermined power is an erase power corresponding to the first predetermined control signal.

14. The power control method of claim 11 wherein a close loop configuration is established when deriving the fifth control voltages.
